(19) United States
(12) Patent Application Publication
(10) Pub. No.: US 2017/0268955 A9
(43) Pub. Date: Sep. 21, 2017

(54) AIRTIGHTNESS TESTING APPARATUS AND METHOD OF USING SAME

(71) Applicant: Jonathan P. Haehnel, Fairlee, VT (US)

(72) Inventor: Jonathan P. Haehnel, Fairlee, VT (US)

(21) Appl. No.: 14/637,396

(22) Filed: Mar. 4, 2015

Related U.S. Application Data
(60) Provisional application No. 61/947,048, filed on Mar. 3, 2014.

(51) Int. Cl. G01M 3/04

(52) U.S. Cl. CPC G01M 3/04

(57) ABSTRACT

Disclosed is an apparatus and method of using same for testing the airtightness of surfaces, the apparatus having an air pump in fluid communication with an input port and an output port, so as to induce an airflow from said input port to said output port, said airflow driven by a differential air pressure generated by said air pump, a gaseous suspension source disposed within said air pressure generator so as to entrain a gaseous suspension in said airflow so as to create an entrained suspension, and a conduit in fluid communication with said output port configured to constrain a flow of said entrained suspension therethrough so as to deliver said entrained suspension under pressure through an applicator port distal to said output port.

### CROSS-REFERENCE TO RELATED APPLICATIONS

This patent application claims the benefit of the filing date of U.S. provisional patent application No. 61/947,048, filed Mar. 3, 2014, the disclosures of which are incorporated by reference herein in their entirety.

### BACKGROUND OF THE DISCLOSURE

1. Field of the Disclosure

This invention relates to the field of detecting the airtightness of structures and surfaces.

2. Description of the Related Art

The history of modern airtightness testing could be said to have begun in the 1970's when the Swedes started using fans mounted in windows to pressurize structures. Door-mounted fans were soon experimented with by researchers at Princeton University in the late 1970's and the first commercially available blower door came on the U.S. market in 1980.

A blower door may be used to test the airtightness of a completed building. A door of a house or other building is removed from its hinges and replaced with the blower door—a door with a powerful fan built into it. All the outer doors and windows of the building are then closed and all the interior doors opened. The blower door is shut and sealed, the fan turned on, and the equilibrium pressure inside the building is measured. Usually air is blown out of the building causing depressurization. The difference in pressure between the inside and outside of the building can be used to calculate leakage, the total cross sectional area of all the leaks being proportional to the square root of the pressure differential.

The actual location of the leaks may sometimes be ascertained by reversing the blower door fan and pressurizing the building. A smoker or fogger may then be placed within the structure and one might then visually inspect the exterior of the building to see if and where any smoke is leaking out of the building.

There is a problem in all this, however. Detecting a leak after the structure is completely built raises problems. There may be, and usually are, considerable costs involved in correcting a problem that has been “entombed” into the completed architecture. A blower door is of no help here, as it cannot be used until at least the outer shell of the structure is completed.

### BRIEF DESCRIPTION OF THE DISCLOSURE

Disclosed is an apparatus for testing the airtightness of surfaces, the apparatus having an air pump in fluid communication with an input port and an output port, so as to induce an airflow from said input port to said output port, said airflow driven by a differential air pressure generated by said air pump, a gaseous suspension source disposed within said air pressure generator so as to entrain a gaseous suspension in said airflow so as to create an entrained suspension, and a conduit in fluid communication with said output port configured to constrain a flow of said entrained suspension therethrough so as to deliver said entrained suspension under pressure through an applicator port distal to said output port.

### BRIEF DESCRIPTION OF THE DRAWINGS

FIG. 1 Is a schematic cross-sectional side view of the airtightness testing apparatus of the disclosure.

FIGS. 2a and 2b are cross-sectional side views of an extension.

FIG. 3 is a photograph of a method of using the apparatus of the disclosure.

FIG. 4a is an isometric view of a test module of the disclosure for testing planer surfaces.

FIG. 4b is an isometric view rendering of a transparent test module of the disclosure for testing planer surfaces.

FIG. 5a is a front-right-top isometric view of a test module of the disclosure for testing two-plane corners.

FIG. 5b is a right-back-bottom isometric view of the test module of FIG. 5a.

FIG. 6 is a photograph of a method of using a planer test module of the disclosure.

FIG. 7 is a photograph of a method of using a corner test module of the disclosure.

FIG. 8 is an isometric view of a transparent test module of the disclosure for testing planer surfaces such as described with respect to FIG. 4b with the addition of a pressure gauge mounted thereon.

FIGS. 9a through 9d are four axonometric views of a test module of the disclosure for testing vertices.

### DETAILED DESCRIPTION OF THE DISCLOSURE

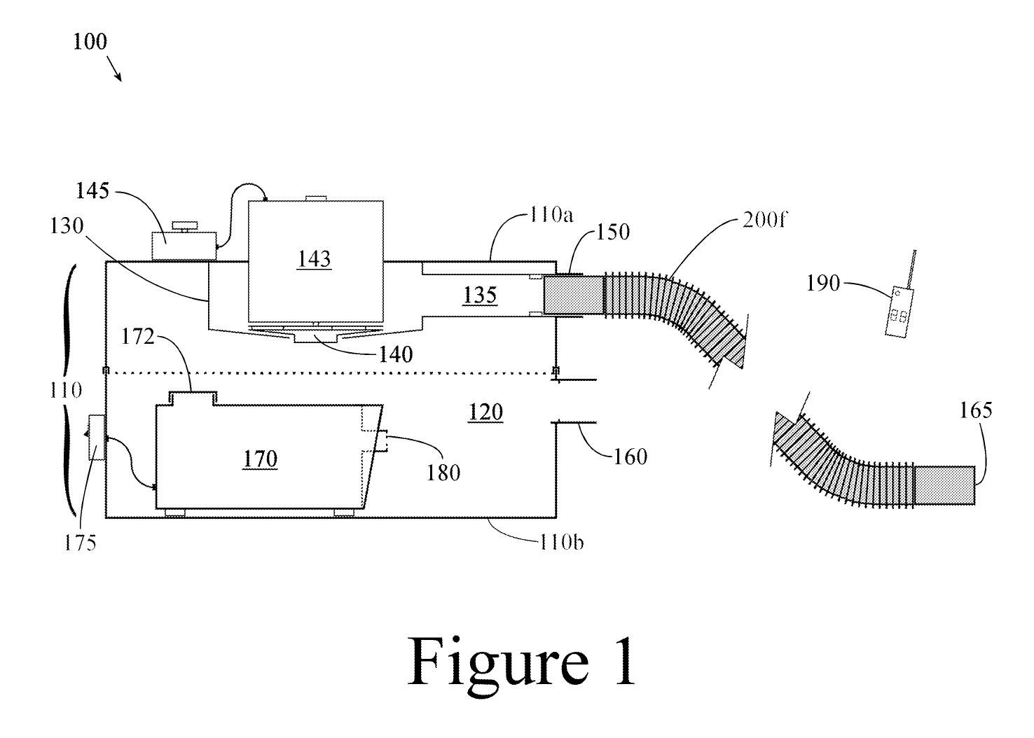

Referring to FIG. 1, there is shown an embodiment of the airtightness testing apparatus 100 of the disclosure. A containment vessel 110 is provided, which may be opened and an interior entrainment chamber 120 may be accessed by separating a first shell 110a from a second shell 110b. Alternatively, a hinged hatch on a containment vessel 110 may be utilized, among other possible ways to provide a chamber.

Integral to the first shell 110a in this embodiment, there is provided an air pump 130, here embodied in the form of a centrifugal air pump having a blower wheel 140 driven by a motor 143, the rotational speed (RPM) of which may be controlled by a motor controller 145. The RPM of the motor 143 may be used to control the air pressure generated at an output port 150. Ideally speaking, the pressure generated at the output port 150 will be proportional to the square of the RPM (or, for a piston pump, the number of strokes per minute), though in practice it will be less than that due to efficiency losses in the particular design and configuration of the air pump 130. The principle here is that the pressure generated is a function of airflow and we are estimating that the airflow is ideally directly proportional to the RPM, but in reality there is always “slippage” when endeavoring to push a gas around. Another factor is the size and shape of the output port. Specifically, operating at 1.0 atmosphere:

Q=K(ΔP)ⁿ (1)

where Q is the airflow in cubic feet per minute, K is a constant, ΔP is the difference between the ambient pressure and the pressure generated by the air pump 130 in pounds per square inch (PSI), and the power n is a value ranging from 0.5 to 1 dependent upon the shape of the of the output port 130, wherein n=0.5 represents a “perfect orifice” and n=1 represents a very long thin crack.

Given a smooth round output port 150 at the end of a pump conduit 135 that is not much longer than about five to ten times the diameter of the output port, we may estimate that n≈0.5 such that:

P=k·Q² (2)

where k=1/K².

The air pump 130 draws its air from an air input port 160, which in the embodiment shown is integral to the lower shell 110b Hence, when the motor 143 is activated, an airflow is established running from the input port 160 into the entrainment chamber 120, driven through the air pump 130, and out the output port 150 into a conduit, shown here by example as a flexible conduit 200f, which serves to extend the reach of the pressurized airflow while constraining the airflow so as to substantially preserve the pressure differential ΔP. The conduit or conduits 200f, 200r ultimately lead(s) to a applicator port 165 at a distal end thereof at a pressure that will be somewhat below that of the output port 150 due to frictional losses between the airflow and the interior walls of the conduit 200f.

Note that the positioning of the components involved is flexible. For example, the air pump 130 could be interposed between the entrainment chamber 120 and the input port 160.

Disposed within the entrainment chamber 120 is a gaseous suspension source 180, which here is shown as the output nozzle of a gaseous suspension generator, which for simplicity will be referred to as a “fog machine” 170 for the purposes of this disclosure. The fog machine 170 will typically be a machine that provides colloidal suspensions such as fog or smoke. A popular and colloidal suspension is glycol fog, for which liquid solutions often advertised as “fog juice” are commercially available for use with commercially available fog machines designed to work with them such as, for example, the MBT Lighting model FM400 “Lil' Critter” micro fogger.

For the purposes of this disclosure, a gaseous suspension is a non-colloidal or colloidal suspension of liquid or solid particulates in a gas or gas mixture (e.g., air). A non-colloidal gaseous suspension is one in which the particulates eventually settle out as a sediment or condensate, while a colloidal gaseous suspension is one in which the particulates remain suspended (at least for a desired period of time).

Colloidal suspensions (in a gas) include liquid suspensions, such as fog (water), glycol fogs, and hairsprays. Colloidal liquid suspensions in a gas are also known as “liquid aerosols”.

Also classified as colloidal suspensions are solid suspensions, such as smoke and ice clouds, though smoke cause by the burning of hydrocarbons also include water vapor in addition to solid particulates. Solid colloidal suspensions in a gas are also known as “solid aerosols”.

Non-colloidal liquid and solid suspensions include fine dust, soot, sea salt and cloud droplets.

If the entrainment chamber is large enough, as it is in the embodiment shown, one may dispose the entire fog machine 170 inside the entrainment chamber 120. In fact, if the chamber is large enough and the fog machines 170 small enough, one may dispose a plurality of fog machines 170 in the entrainment chamber 120, each charged with a different colored or type of fog juice.

When disposing a fog machine 170 inside the entrainment chamber 120, it would normally be necessary to open the entrainment chamber 120 to gain access to a refill cap 172 to refill the fog machine 170 with whatever fogging or smoking solution it was designed for. Alternatively, the fog machine 170 may be mounted outside of the entrainment vessel 170, or even the containment vessel 110 itself, and a hose or pipe run from the output nozzle through a wall of the containment vessel 110 to the interior entrainment chamber 120. The end of the hose or pipe disposed within the entrainment chamber 120 is then defined as the gaseous suspension source 180.

The rate (volume/second) of gaseous suspension provided will typically be modulated by a fog controller 175. Note that either or both the motor controller 145 or fog machine controller 175 may be provided as remotely controlled receivers, controllable by the operator with a remote control transmitter 190.

When an airflow is present, running from the input port 160 toward the air pump 130, a gaseous suspension emitted from the gaseous suspension source 180 into the entrainment chamber 120 will be entrained in the airflow. The resultant entrained suspension will be blown out the output port 135 under the force of a pressure differential ΔP which will be substantially maintained (though with some diminution) at the applicator port 165.

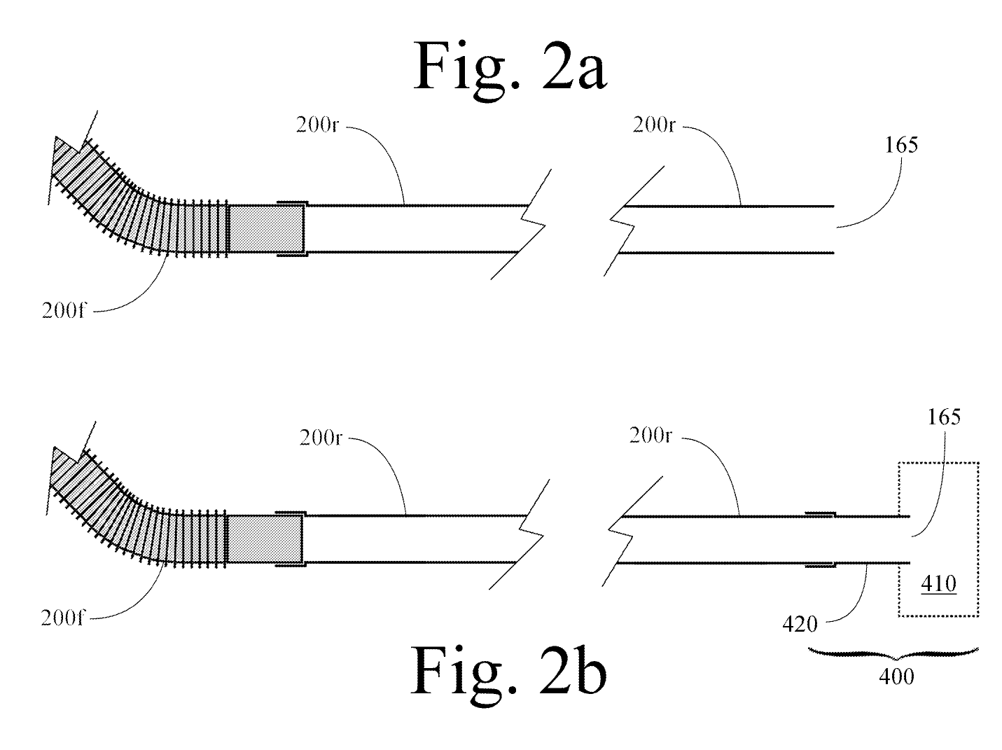

Referring to FIG. 2a, there is shown a rigid conduit extension 200r that is configured to couple with a distal end of either the output port 150 of the containment vessel 110 or the last of any number of flexible conduits 200f or other rigid conduits 200r. Note how the addition of additional sections of conduit advances the applicator port 165 to the distal end of the last extension conduit attached. Rigid conduit 200r extensions allow the user to position the applicator port 165 to regions otherwise out of reach and thereby afford greater precision and control over the movement and positioning of the applicator port 165.

Referring to FIG. 2b, there is shown the configuration of FIG. 2a, but with a test module 300 attached. As will be described below, test modules 400 may be configured in a variety of shapes and sizes as desired and are used to substantially hermetically seal-off areas of architectural surfaces and focus entrained suspensions upon a defined surface at a precisely controlled pressure differential. Each test module 400 comprises a pressure chamber 410 and a chamber coupler 420 that attaches to a conduit 200, thereby bringing the conduit 200 into fluid communication with the interior of the pressure chamber 410. Note that attachment of a test module 400 to a conduit advances the position of the applicator port 165 to the end of the chamber coupler 420 that opens into the pressure chamber 410.

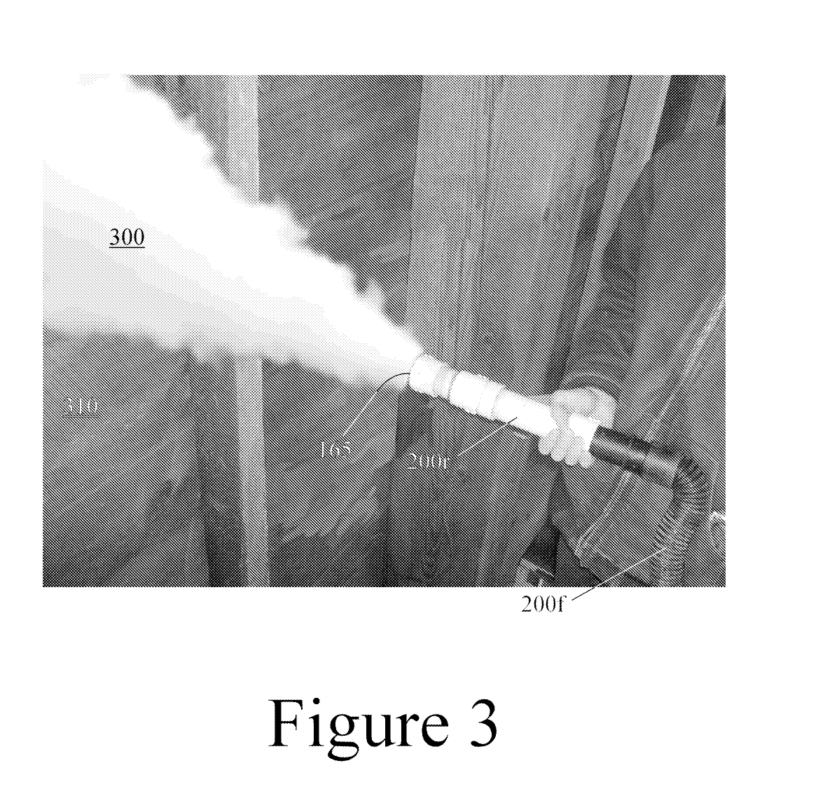

Referring to FIG. 3, there is shown a photograph of the use of the apparatus of the disclosure in the basic configuration as shown in FIG. 2a, namely a flexible conduit 200f in attachment to a rigid conduit 200r. As can be seen, the user is grasping the rigid conduit 200r and directing a stream of an entrained suspension (here a colloidal glycol fog) 300 emanating under pressure from the applicator port 165 toward an architectural element 310. Not shown is the “spotter”, who is on the other side of the structural element 310 looking to see where and if any of the fog 300 is leaking through.

Suitable pressure differentials for use with the apparatus of the disclosure would be from At least about 0.001 pounds per square inch (PSI) and about 0.002 to about 5 PSI for most projects. In general, a variable range of from about 0.5 to about 4 PSI may be sufficient.

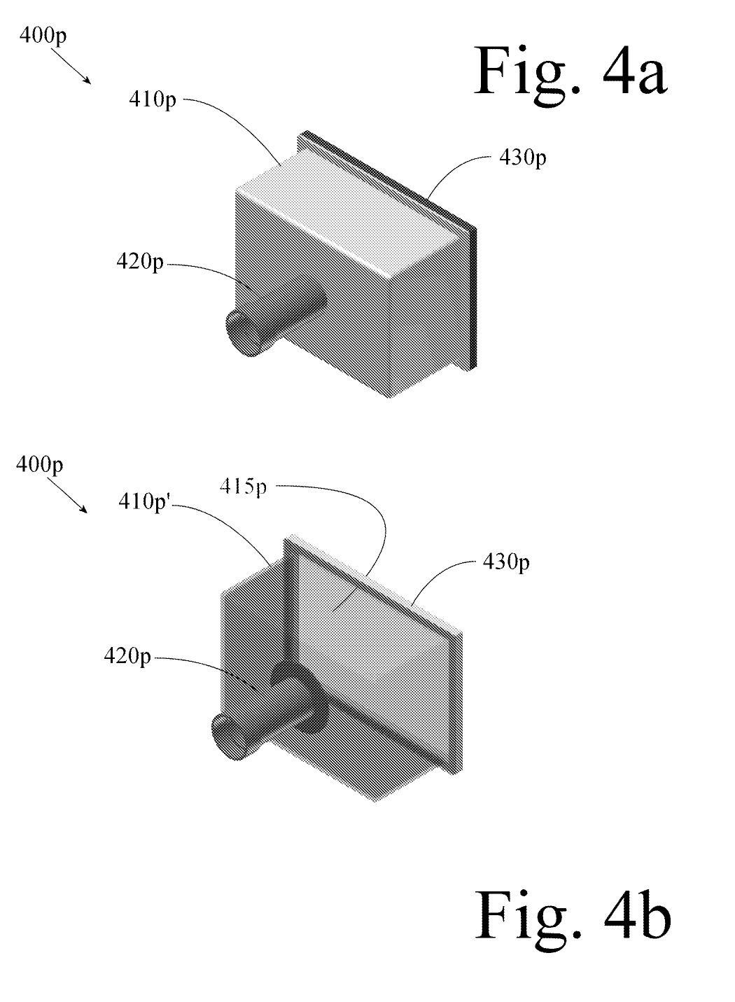

Referring now to FIG. 4a, there is shown a plane test module 400p configured for testing the airtightness of planer surfaces, such as walls, ceilings, and floors. A pressure chamber 410p defines a planar opening 415p in conjunction with a resilient seal 430p. A chamber coupler 420p depends outward from the pressure chamber 410p perpendicular to an imaginary plane on which the resilient seal 430p sits The result of this configuration is that the user need only push forward to tighten the seal 430p against a wall or other planar surface.

Referring now to FIG. 4b, there is shown a transparent planar test module 400p′ which is identical in structure to that of FIG. 4a excepting that a transparent material, such as a polymer plastic, is used to construct a transparent pressure chamber 410p′. The positioning in the drawing is the same as that for the embodiment in FIG. 4a. Here, nearly the entire seal 430p can be seen through the clear pressure chamber 410p′. This embodiment is useful because the user can verify the flow of entrained suspension visually.

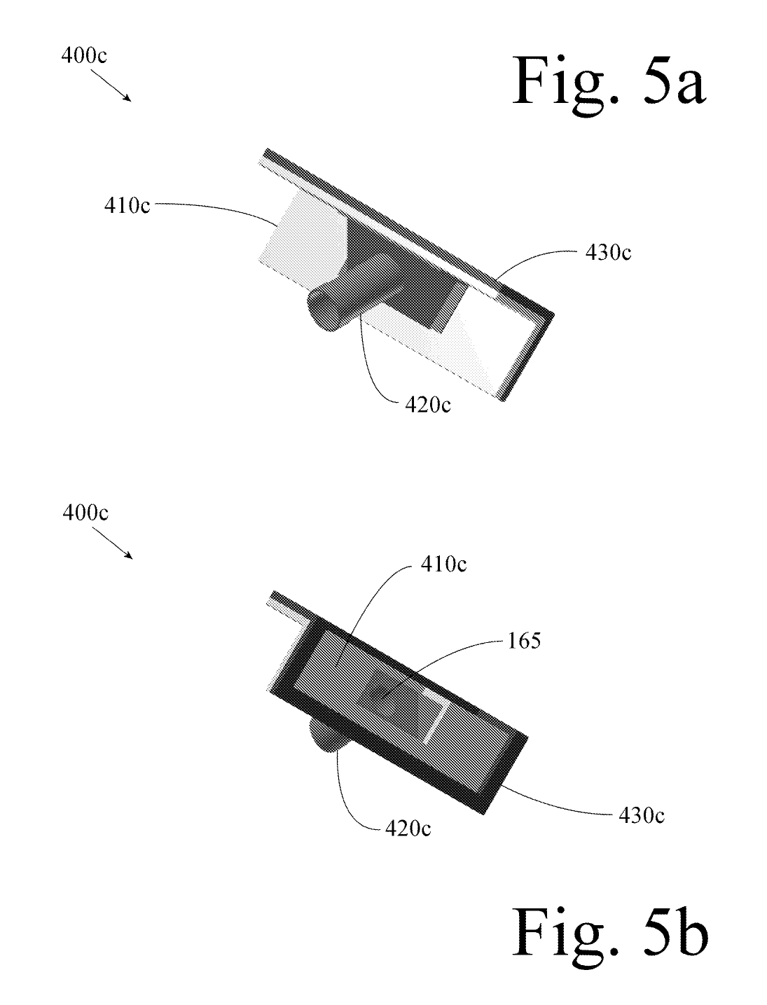

Referring now to FIG. 5a, there is shown a corner test module 400c configured to test the airtightness of corners defined by two planes, such as the corner between a pair of walls, a wall and a ceiling, a wall and a floor, and so forth. As can be seen, a corner chamber coupler 420c is configured to fit to a right-angle pressure chamber defining a three-dimensional opening defined by the intersection of two planes surrounded by a resilient seal ring 430c.

Referring to FIG. 5b, there is shown the back of the corner test module of FIG. 5a, exposing the applicator port 165 in a end of the corner chamber coupler 420c.

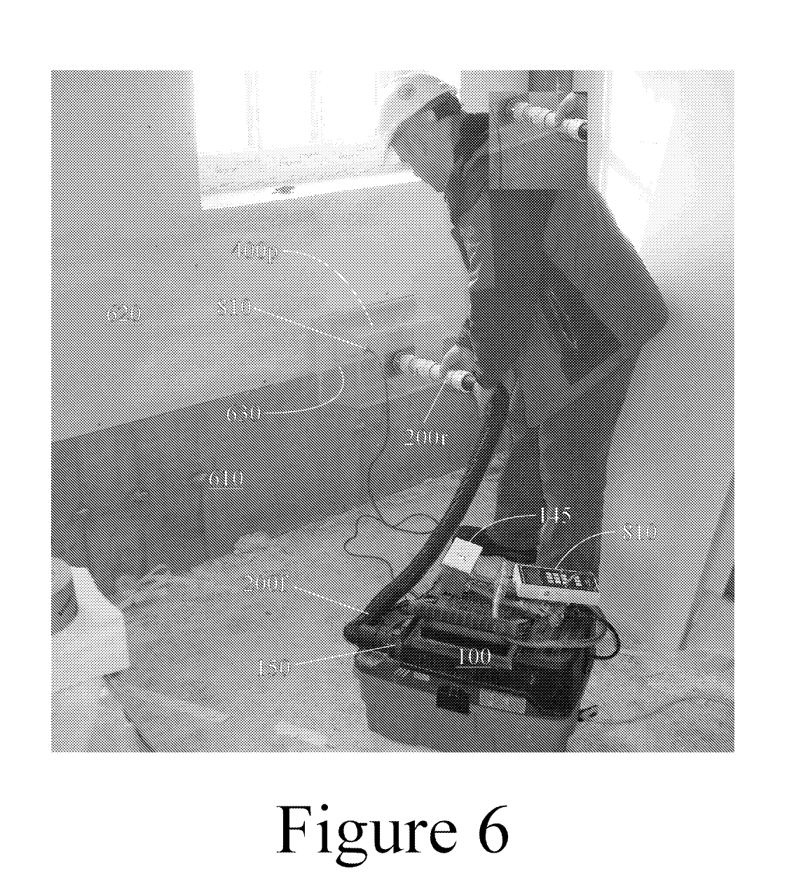

Referring to FIG. 6, is a photograph of a user of the apparatus of the disclosure utilizing a planer test module 400p to test the airtightness of a join 630 between a sill plate hidden behind the gypsum cladding at the base of an exterior wall 620 and a concrete foundation wall 610.

Note also that the airtightness testing apparatus 100 appearing in FIG. 6 is constructed by modification of a Rigid model WD5500 Wet/Dry Vac vacuum cleaner. A digital pressure gauge 800 has been provided in communication with the planer test module 400p by way of a pressure gauge port 810. One may recognize the motor controller 145 as a commercially available light dimmer interposed between the Wet/Dry Vac and the power supply. Note also that this embodiment is portable, which is convenient when moving about a construction site from structural element to structural element, testing for leaks. In the embodiment shown “portable” means the user can carry it. For larger and/or heavier units it may be desirable mount the airtightness testing apparatus 100 on wheels so as to be rollable. In either case, it is an advantage for the testing apparatus 100 to be moveable.

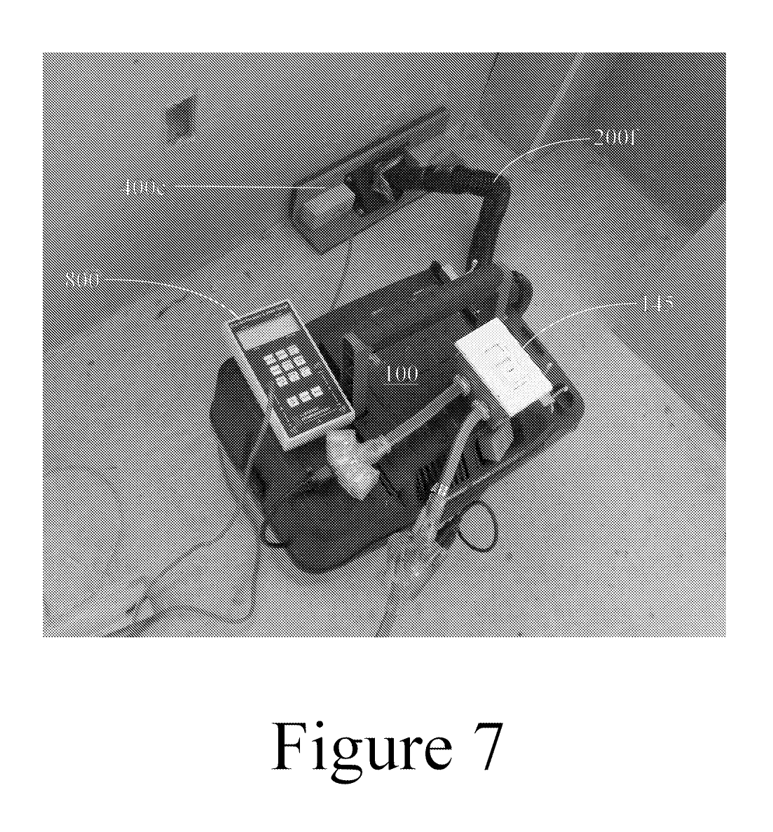

Referring to FIG. 7, there is shown a corner test module 400c prototype being test-fitted by pressing into a corner.

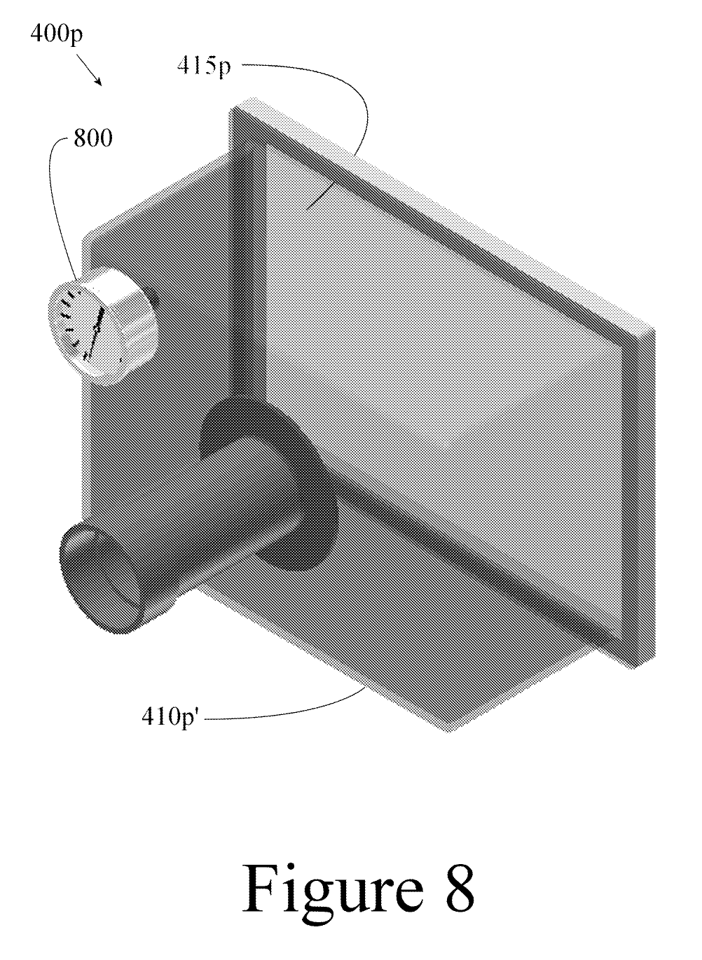

Referring to FIG. 8, there is shown a planar test module 400p with a pressure gauge 800 mounted directly into the pressure gauge port 810 (see FIG. 6). A pressure gauge may be useful for determining whether it's worth consuming “fog juice” for further testing. For example, if the maximum PSI generated on a particular airtightness testing apparatus 100 happens to be 5.0 PSI, the user could set that pressure with the smoke machine 170 shut off, push the test module 400 tightly against the surface, and the read the pressure off the pressure gauge 800. If the pressure gauge reads at least close to 5.0 PSI, then there is no leak, or at least not any substantial leak.

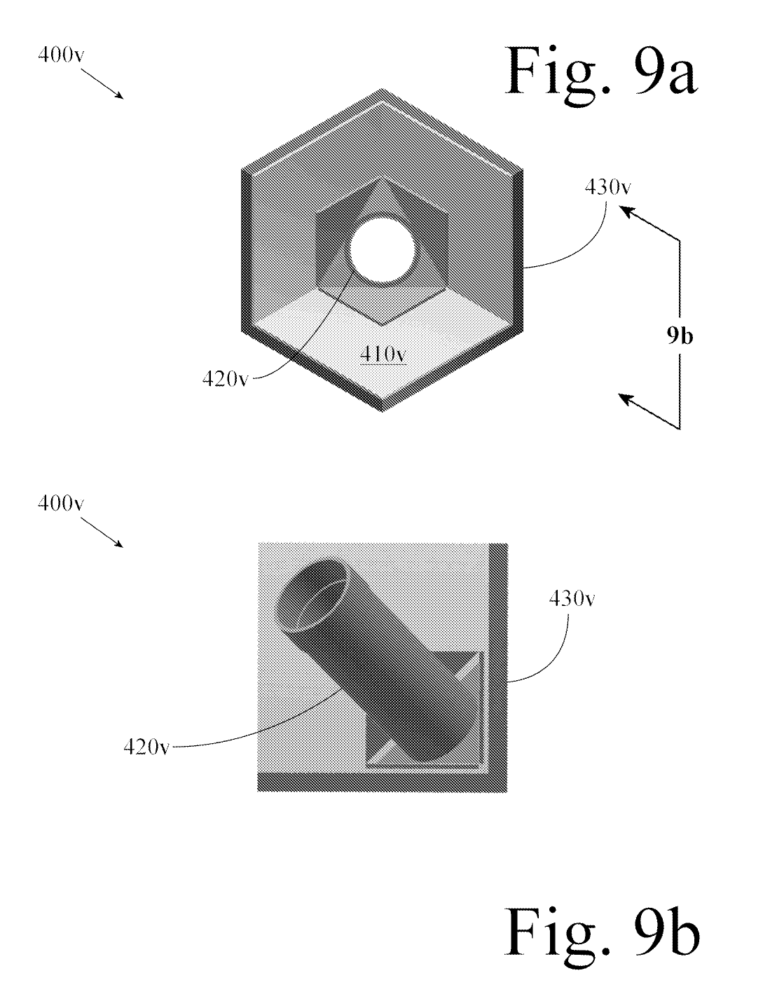

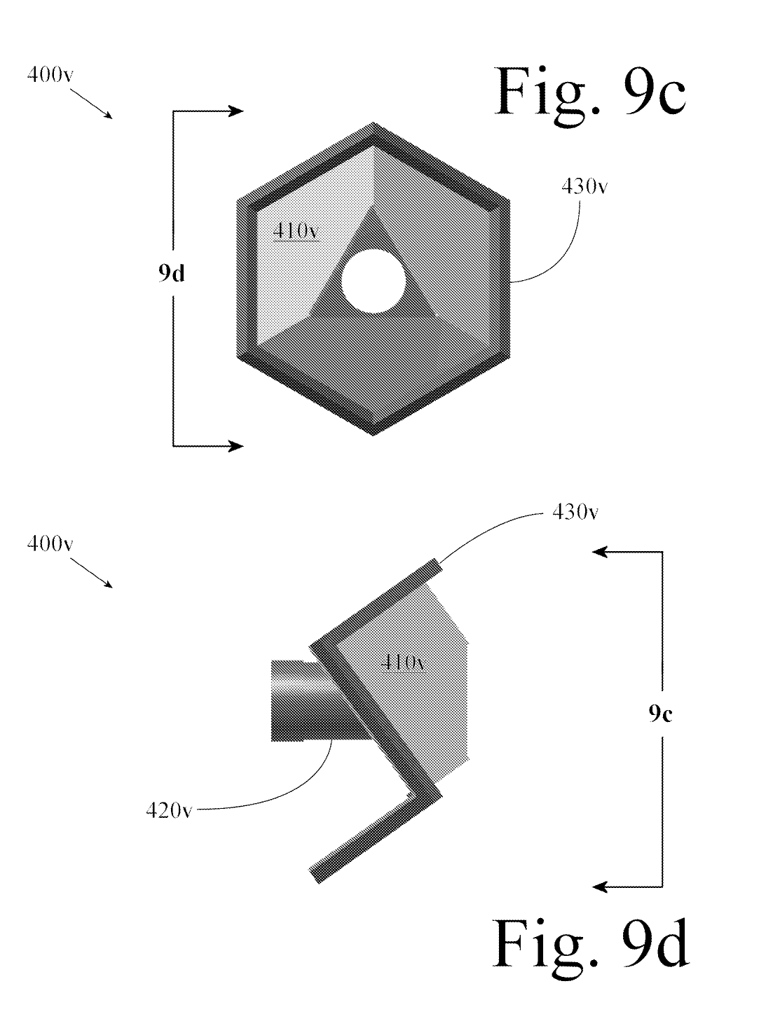

Referring to FIG. 9a through FIG. 9d there are shown four axonometric views of a vertex test module 400v, useful for testing the airtightness of 3-plane corners, such as those formed by the intersection of two walls and a ceiling or floor. FIG. 9a is a view directly into a vertex coupler 420v, such that a hypothetical viewer would see a corner being tested through the hole in the center. Conversely, FIG. 9c shows the rear of the vertex test module 400v as seen from the point of view of the corner being tested, such that you would see the eye of the hypothetical viewer from the description of FIG. 9a.

A variety of shapes and sizes that may be configured for test modules 400 and this disclosure is not to be interpreted to be limited to the three shown. Additional configurations are possible, as long as they have in common a pressure chamber 410, a chamber coupler 420, and a seal 430. Note that if the pressure chamber 410 is made of a resilient enough material, the rim defining its opening could double as the seal 430.

As can be seen, the apparatus of the disclosure allows for the first time the airtightness testing of components and elements of a structure that is under an early stage of construction wherein the structure is not sufficiently sealed so as to allow for conventional blower door testing. This is achieved in a first instance by delivering a pressurized airstream of an entrained suspension to the structural element and checking for any leakage of the entrained suspension therethrough, in a second instance by delivering a pressurized airstream of an entrained suspension to a test module at elevated pressures and checking for any leakage of the entrained suspension, and in a third instance by delivering a pressurized airstream to a test module, with or without an entrained suspension, and checking for any leakage by observing the resultant pressure differential between the pressure chamber of the test module and ambient atmospheric pressure.

The foregoing disclosures relate to illustrative embodiments of the invention and modifications may be made without departing from the spirit and scope of the invention as set forth in, and limited only by, the claims herein.

In the claims herein—unless explicitly indicated otherwise—the use of the word “or” is to be construed as the inclusive “or” in accordance with common usage in the engineering art.

1-20. (canceled)

21. An airtightness testing apparatus, comprising:
a containment vessel at least partially defining an internal entrainment chamber having an inlet port and an outlet port;
a gaseous suspension generator; and
a pressurizing device having a low-pressure side in fluid communication with the gaseous suspension generator and the inlet port of the internal entrainment chamber, and a high-pressure side in fluid communication with the outlet port.

22. The air tightness testing apparatus of claim 21, wherein:
the pressurizing device is a blower wheel; and
the gaseous suspension generator is located inside the containment vessel.

23. The air tightness testing apparatus of claim 22, further including a motor mechanically connected to the pressurizing device.

24. The air tightness testing apparatus of claim 21, wherein:
the containment vessel includes a first shell removably connected to a second shell; and
further including a motor controller located outside the containment vessel.

25. The air tightness testing apparatus of claim 24, wherein the gaseous suspension generator includes a suspension refill accessible from inside the containment vessel.

26. The air tightness testing apparatus of claim 24, further including a gaseous suspension generator control located outside the containment vessel.

27. The air tightness testing apparatus of claim 26, further including a remote transmitter in communication with at least one of the motor controller and the gaseous suspension generator controller

28. The air tightness testing apparatus of claim 21, further including:
a testing module; and
a conduit extending from the containment vessel to the test module.

29. The air tightness testing apparatus of claim 28, wherein the testing module includes:
a body at least partially defining an internal pressure chamber in fluid communication with the entrainment chamber of the containment vessel via the conduit, the internal pressure chamber having at least one side open to the atmosphere; and
a resilient seal disposed around a periphery of the at least one open side.

30. The air tightness testing apparatus of claim 29, wherein the at least one open side includes a generally planar face on which the resilient seal is mounted.

31. The air tightness testing apparatus of claim 30, wherein the at least one open side includes two open sides oriented generally orthogonal to each other.

32. The air tightness testing apparatus of claim 31, wherein the resilient seal is continuous and surrounds the two open sides.

33. The air tightness testing apparatus of claim 30, wherein the at least one open side includes three open sides oriented generally orthogonal to each other.

34. The air tightness testing apparatus of claim 33, wherein the resilient seal is continuous and surrounds the three open sides.

35. A testing module for an air tightness testing apparatus, comprising:
a body;
an internal pressure chamber at least partially defined by the body;
an inlet opening formed in the body and in fluid communication with the internal pressure chamber; and
an outlet opening formed in at least one generally planar side of the body and being in fluid communication with the internal pressure chamber; and
a resilient seal disposed around a periphery of the outlet opening and connected to the at least one generally planar side of the body.

36. The testing module of claim 35, wherein:
the at least one generally planar side includes two generally planar sides oriented generally orthogonal to each other;
the resilient seal is continuous and surrounds the two generally planar sides.

37. The air tightness testing apparatus of claim 36, wherein:
the air tightness testing apparatus of claim 35, wherein the at least one generally planar side includes three generally planar sides oriented generally orthogonal to each other; and
the resilient seal is continuous and surrounds the three generally planar sides.

38. A method of testing airtightness of a structure, comprising:
drawing air into an entrainment chamber;
generating a gaseous suspension inside of the entrainment chamber;
directing a pressurized mixture of the air and the gaseous suspension from the entrainment chamber to a testing module that is temporarily connectable to the structure.

39. The method of claim 38, further including selectively adjusting at least one of a pressure of the air and a rate of generating the gaseous suspension.

40. The method of claim 39, wherein selectively adjusting at least one of a pressure of the air and a rate of generating the gaseous suspension includes:
receiving a remotely generated signal indicative of a desire to adjust the at least one of a pressure of the air and a rate of generating the gaseous suspension; and
responsively adjusting at least one of a blower wheel speed and temperature of a gaseous suspension generator.
